(19) United States
(12) Patent Application Publication
(10) Pub. No.: US 2022/0354088 A1
(43) Pub. Date: Nov. 10, 2022

(54) COOLING STRUCTURE OR ASSEMBLY USING PHASE CHANGE MATERIAL

(71) Applicant: Glacier Tek LLC, Minneapolis, MN (US)

(72) Inventors: RoxAnne Best, Minneapolis, MN (US); Tyler Zwirtz, Minneapolis, MN (US); Benedict Welter, Richfield, MN (US); Luke Haun, Minneapolis, MN (US); William Johnson, SR., Minneapolis, MN (US)

(73) Assignee: Glacier Tek LLC, Minneapolis, MN (US)

(21) Appl. No.: 17/736,362

(22) Filed: May 4, 2022

Related U.S. Application Data
(60) Provisional application No. 63/183,713, filed on May 4, 2021.

(51) Int. Cl. A01K 13/00; A47G 9/02; F28D 20/02

(52) U.S. Cl. CPC A01K 13/008; A47G 9/0215; F28D 20/023

(57) ABSTRACT

Cooling blankets for humans and animals including a plurality of chambers containing phase change material. The panels include upper and lower layers of weldable material with a plurality of linear welds connecting them and forming PCM chambers which extend across the panels in a generally linear, side-by-side arrangement. The panels further include fastener elements to connect adjacent panels and form a larger blanket. The shape and configuration of the panels and the PCM chambers allows them to be rolled for easy transportation and for charging.

### CROSS REFERENCE TO RELATED APPLICATION

This application claims priority to U.S. Provisional Application No. 63/183,713, filed May 4, 2021, the disclosure of which is herein incorporated by reference in its entirety.

### BACKGROUND

Cooling packs are typically small units for cooling parts of a body, such as an injured joint of sore muscle. It is difficult to make larger cooling units or several reasons. For one, the cooling material inside cooling packs is often rigid, making them difficult to apply effectively to larger areas. In addition, cooling packs need to be charged by placing them in a cool environment such as a freezer, which is increasingly difficult as their sizes increase. Also, as their size increases, they become more heavy and unwieldy. As a result, existing cooling packs are limited in size and utility, even though it is often desirable to cool larger areas than a single joint.

### BRIEF DESCRIPTION OF THE DRAWINGS

FIG. 1A is a plan view of a cooling panel of the present application having an encapsulation structure.

FIG. 1B is a cross-sectional view as taken along line B-B of FIG. 1A

FIG. 1C is a cross-section view as taken along line C-C of FIG. 1A.

FIG. 1D is a detailed illustration of portion 1D of FIG. 1A.

FIG. 1E illustrates process steps for fabricating the panel and encapsulation structure of FIGS. 1A-1D.

FIG. 1F is a flow chart illustrating fabrication steps for the panel and encapsulation structure of FIGS. 1A-1E.

FIG. 2A illustrates an embodiment of a panel having multiple encapsulation structures of the present application.

FIG. 2B is a cross-sectional view as taken along line B-B of FIG. 2A.

FIG. 2C illustrates process steps for the panel illustrated in FIGS. 2A-2B.

FIG. 2D is a flow chart illustrating fabrication steps for the panel illustrated in FIGS. 2A-2C.

FIG. 3A is an exploded view of another embodiment of an encapsulation structure including an inner encapsulation pouch.

FIG. 3B is a cross-sectional view as taken along line B-B of FIG. 3A.

FIG. 3C is a cross-sectional view as taken along line C-C of FIG. 3A.

FIG. 3D illustrates process steps for fabricating the inner encapsulation pouch filled with a phase change material (PCM) for cooling.

FIG. 3E illustrates process steps for fabricating a panel with multiple encapsulation structures.

FIG. 4A illustrates a horse blanket formed of a plurality of cooling panels of the present application.

FIG. 4B illustrates an underside of the cooling panel illustrated in FIG. 4A.

FIG. 4C illustrates multiple cooling panels connected to form a horse blanket of the present application.

FIG. 4D is a detailed view of portion 4D of FIG. 4C.

FIG. 4E is a cross-sectional view generally taken along line 4E-4E of FIG. 4D.

FIG. 4F illustrates a multiple layered panel including a tab portion forming a fastener tab for connecting adjacent panels.

FIG. 4G illustrates an inner pouch filled with PCM having a magnet to form a fastener element to connect adjacent panels.

FIG. 4H illustrates process steps for fabricating the inner pouch illustrated in FIG. 4G.

FIG. 4I illustrates another embodiment of a horse blanket including multiple panels connected through hook and loop fastener elements.

FIG. 5A illustrates a cooling collar for a horse including multiple encapsulation structures.

FIG. 5B illustrates an underside of portion 5B of FIG. 5A.

FIG. 5C also illustrates the cooling collar shown in FIG. 5A.

FIG. 5D illustrates another embodiment of a cooling collar.

FIG. 5E illustrates a collar support for the cooling collar of the types illustrated in FIGS. 5A-5C.

FIG. 5F illustrates the cooling collar removably connected to the collar support for use.

FIGS. 5G-5I illustrate embodiments of the cooling panels and collar or chest panel inside a portable cooler for cooling.

FIG. 6A illustrates another embodiment of a horse blanket including a plurality of cooling panels.

FIG. 6B illustrates an embodiment of a horse blanket including a plurality of cooling panels of the present application.

FIGS. 6C-6E illustrate embodiments of a horse blanket including a plurality of encapsulated panels.

FIGS. 7A-7B illustrate a fly sheet for use with the cooling panels of the horse blanket of the present application.

FIG. 7C illustrates an inner pocket formed along a bottom edge of the fly sheet illustrated in FIGS. 7A-7B.

FIG. 7D is a cross-sectional view taken along lines D-D of FIG. 7C.

FIG. 7E illustrates cooling panels of the present application on a horse.

FIGS. 8A-8B illustrates a body vest formed of one or more encapsulation structures having a plurality of baffle features.

FIG. 8C illustrates a leg wrap formed of one or more encapsulation structures including a plurality of baffle features.

It should be understood that the above FIGS. are for illustrative purposes and are not necessarily drawn to size.

### SUMMARY

Various embodiments include cooling blankets that may be configured for use with humans or animals. In various embodiments, the cooling embodiments include multiple panels which may be connected together to form a larger blanket. In this way, the individual panels are smaller, making them more manageable and easier to cool, while still allowing for a larger and more useful blanket.

Various embodiments include a cooling blanket for cooling a human or animal. The cooling blanket may include a plurality of panels, such as two panels. Each panel may generally rectangular in shape, having first and second opposing edges and third and fourth opposing edges, the first panel comprising. Each panel may include an upper layer of weldable material and a lower layer of weldable material adjoined to the upper layer of weldable material along the first, second, third and fourth opposing edges. Each panel may further include a plurality of linear welds connecting the upper layer to the lower layer, the plurality of linear welds extending across the panel from the first to the second edges, and a plurality of chambers extending across the panel from the first and second edges and containing phase change material. The first panel may include a fastener element located at the second edge, while the second panel may include a fastener element located at the first edge. The fastener elements of the first panel may be configured to releasably connect to the fastener element of the second panel to form the cooling blanket. The fastener elements may be magnets, for example. In some embodiments, the second panel also includes a flap located at the first edge and extending from the third to the fourth edges, and the fastener elements of the second panel may be located in the flap. In such embodiments, when the first and second panels are connected by the fastener elements, the flap of the second panel may overlap the second edge of the first panel.

The phase change material used in the cooling blanket may include pellets of a phase change material suspended in an aqueous gel. The first and second panels may also include handles, which may be located midway between the third and fourth edges of the first and second panels. In some embodiments, the panels include a plurality of elongated encapsulation pouches insertable into, and removable from, the plurality of chambers, wherein the encapsulation pouches contain phase change material.

In some embodiments, the first edge of the first panel extends inward, toward a center of the first panel, at a center of the first edge to form a notched portion. The notched portion may be sized to fit around a base of a neck of a horse.

In other embodiments, the cooling blanket may be configured for use with a horse. The cooling blanket may include the various embodiments of the first and second panels as described above and may further include a third panel configured to encircle the neck of a horse on its chest. The third panel may be generally C-shaped, having a first and second curved opposing edges and with first and second outer ends. The third panel may include an upper layer of weldable material, a lower layer of weldable material adjoined to the upper layer of weldable material along the first and second curved opposing edges, a plurality of linear welds connecting the upper layer to the lower layer, the plurality of linear welds extending across the panel from the first to the second curved edges, a plurality of chambers extending across the panel from the first and second curved edges and containing phase change material, and a pair of fastener elements located at the first and second outer ends and configured to releasably connect to each other. The third panel may further include a pair of handles located in proximity to the first and second outer ends. The second edge of the second panel flares outward at a center of the second edge to extend across a rear portion of the horse.

In some embodiments, one or more or all of the panels may include baffle features such as spot welds. In various embodiments, spot welds connecting the upper layer to the lower layer within one or more of the chambers. For example, in some embodiments, the chambers of the first and second panels alternate between chambers including spot welds and chambers without spot welds.

### DETAILED DESCRIPTION OF ILLUSTRATIVE EMBODIMENTS

The present application relates to a temperature control structure or assembly that uses phase change materials (PCM) to maintain or cool the temperature of a person, animal or object. In illustrated embodiments, the structure or assembly utilizes one or more cooling panels to form the structure or assembly. Illustrative embodiments described disclose generally rectangular shaped cooling panels however application is not limited to rectangular or particular shaped panels.

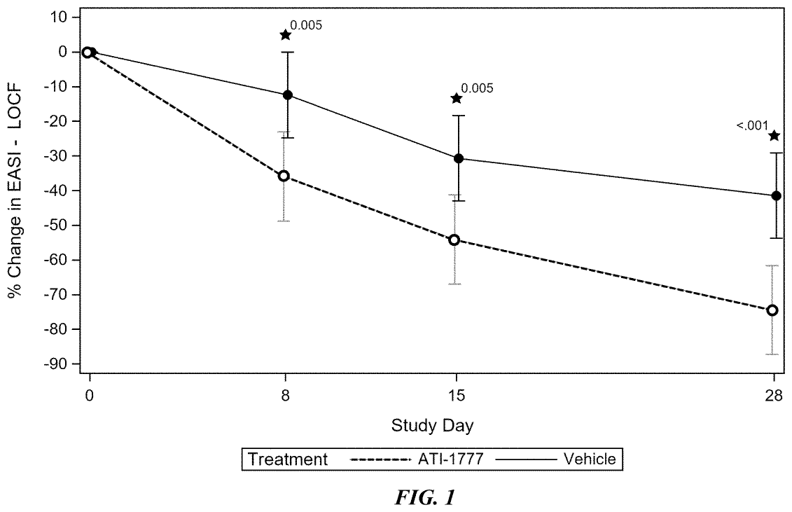

FIGS. 1A-1B illustrates an embodiment of a cooling panel 100 of the present application. As shown, the cooling panel 100 includes an encapsulation structure 102 including an inner chamber 104 filled with PCM material 106 as shown in FIG. 1B. The encapsulation structure 102 is formed via upper and lower layers 108, 110 connected or sealed along perimeter edges a-d to form encapsulation seams 112a-112d sealing the inner chamber 104 of the encapsulation structure 102. In the illustrated embodiment, the upper and lower layers 108, 110 are connected or joined to form baffle features 115 on the encapsulation structure as shown in FIGS. 1C-1D. As shown, the baffle features 115 are spaced between perimeter edges a-d of the encapsulation structure 102 to form a waffle or dimple encapsulation pattern. The pattern of baffle features 115 as shown are spaced to provide a relatively flexible structure and maintain a balanced distribution of PCM within the inner chamber 104.

FIG. 1E progressively illustrates fabrication of the panel 100 of the embodiment shown in FIGS. 1A-1D. Upper and lower layers 108, 110 are connected along the perimeter edges a-d to form the encapsulation structure 102 as shown in step 120. As shown, layers 108, 110 are not connected or sealed along an entire length of the perimeter edge c to provide a fill opening 122 opened to the inner chamber 104. In step 124, the upper and lower layers 108, 110 are connected to form the pattern of baffle features 115. In step 126, the inner chamber 104 is filled with PCM through fill opening 122 to form the encapsulated cooling panel. In step 128, the fill opening 122 is sealed to complete seams 112a-112b enclosing the inner chamber 104. In the illustrated embodiment shown, the baffle features 115 include a pattern of spaced spot connections or “spot welds” to form the waffled or dimpled pattern, however, application is not limited to the particular baffle features shown.

FIG. 1F illustrate process steps for forming panel 100. The illustrated process steps include step 130 of connecting one or more upper and lower layers 108, 110 to form seams 112a-d of the encapsulation structure 102 and inner chamber 104. In step 132, baffle features 115 are formed and in step 134 the inner chamber 104 is filled with PCM 106 through fill opening 122. Following step 134, the fill opening 122 is sealed to complete the encapsulation seams 112a-112d enclosing the inner chamber 104 to contain the PCM material within the encapsulation structure 102 as illustrated in step 135.

Illustratively, the upper and lower layers 108, 110 are formed of fabric layers coated with an adhesive coating or layer to connect the upper and lower layers 108, 110 to form the encapsulation seam 112a-112d and baffle features 115. Illustrative fabric layers include nylon, cotton, linen or other microfibers and can be woven or unwoven. In illustrated embodiments, fabric layers are formed of a water or fluid impermeable or semi-impermeable fabric material having a low water vapor transmission rate. The adhesive coating layer is formed of a heat meltable layer or coating such as a PVC coating layer to heat seal or connect layers 108, 110 to form the seams 112a-112d and baffle features 115.

In one illustrative embodiment, the upper and lower layers 108, 110 include a Staftex fabric having a 70 denier/210 thread count nylon fabric with a PVC coating available from Stafford Textiles Limited of Toronto, Canada. The PCV coating in an illustrative embodiment has a thickness between 0.18-0.33 mm or a thickness of 0.18 mm in one embodiment and a thickness of 0.33 mm in another embodiment. In other embodiments, the encapsulation structure 102 includes multiple upper and lower layers 108, 110 including one or more fabric layer(s) and/or one or more polymer or adhesive layers to form the panels.

In illustrative embodiments, the PCM is formed of PCM pellets suspended in an aqueous gel solution. Example embodiments of the PCM 106 are disclosed in PCT Application No. US2018/041431 which is hereby incorporated by reference in its entirety into the present application. Generally, the higher the ratio of pellets to solution the greater the thermal cooling performance and the lower the ratio of pellets the greater flowability within the inner chamber 104. Illustrative ratios of pellets to aqueous gel for the encapsulation structure 102 include 50:50, 40:60, 60:40, 30:70, 70:30 however, application is not limited to the particular ratios disclosed. In one embodiment, PCM may comprise 60% aqueous gel (1% sodium polyacrylate) and 40% pellets.

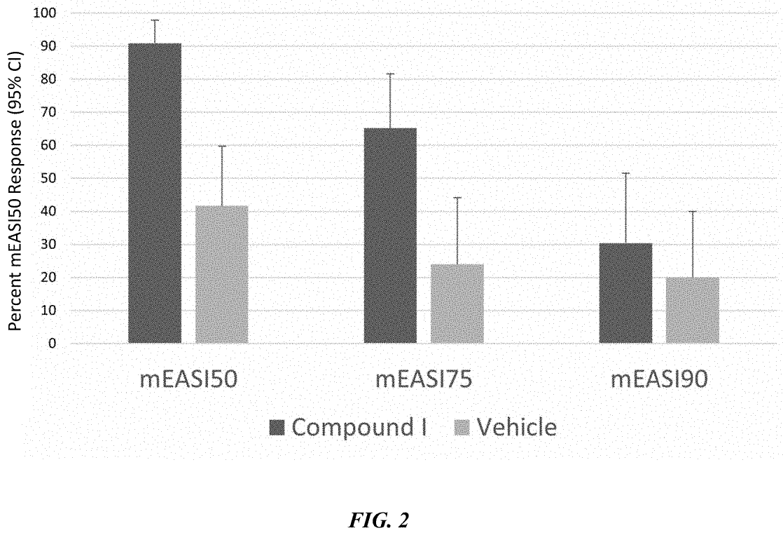

FIGS. 2A-2B illustrate another embodiment of a panel 100 of the present application which as shown includes multiple encapsulation structures 102A-102E providing inner chambers 104A-104E filled with PCM material 106. In the illustrated embodiment, the multiple encapsulation structures 102A-102E include different types which as shown include a plurality of quilted or dimpled encapsulation structures 102B, 102D and a plurality of rectangular encapsulation structures 102A, 102C, 102E. While particular shaped encapsulation structures are shown, application is not limited to a rectangular or particular shape.

The panel shown in FIGS. 2A-2B similarly includes of upper and lower layers 108, 110 as shown in FIG. 2B. As shown, perimeter edges a-d of the upper and lower layers 108, 110 are sealed to form seams 112a-112d extending about a perimeter of the panel 100. The upper and lower layers 108, 110 are also connected to form seams 112e-112h which cooperatively form the multiple encapsulation structures 102A-102E and inner chambers 104A-104E. In particular, the encapsulating structure 102A is formed via encapsulation seams 112a, 112c, 112d & 112e. Encapsulation structure 102B is formed via seams 112a, 112c, 112e, 112f. In the embodiment shown, encapsulation structure 102C is formed via seams 112a, 112c, 112f, 112g. Encapsulation structure 102D is formed via seams 112a, 112c, 112g, 112h and encapsulation structure 102E is formed via seams 112a, 112b, 112c and 112h. Encapsulation structures 102B and 102D include the baffle features 115 as previously described. As previously described, inner chambers 104A-104E of the encapsulation structures 102A-102E are filled with PCM 106 to form the cooling panel 100. As shown, the encapsulation structures 102B, 102D with the baffle features 115 provide a lighter and more flexible structure compared to encapsulation structure 102A, 102C, 102E which form a stiffer rib-like structure.

FIG. 2C illustrate process steps for fabricating the panel 100 with multiple encapsulation structure 102A-102E of FIGS. 2A-2B. As shown, upper and lower layers 108, 110 are connected to form seams 112a-h as shown in step 140. In step 142, the upper and lower layers are spot connected at spaced locations to form the baffle features 115 in the encapsulation structures 102B, 102D. As shown in step 144 the chambers 104A-104E of each of the encapsulation structures 102A-102E are filled with PCM through the fill openings 122 (form via gap in seam 112c) and thereafter in step 146 the fill openings 122 are sealed to complete the encapsulation seams 112a-112d enclosing a perimeter of the panel.

FIG. 2D is a flow chart illustrating fabrication steps for the embodiment shown in FIGS. 2A-2C. As shown in step 150, the upper and lower layers 108, 110 are connected to form seams 112a-112h for the multiple encapsulation structures. In step 152 the baffle features 115 are formed for the waffled or dimpled encapsulation structures 102B, 102D. In step 154, the inner chambers 104A-104E of the encapsulation structures 102A-102E are filled with PCM through fill openings 122 and in step 156, the fill openings 122 are sealed to form the encapsulation structures 102A-102E.

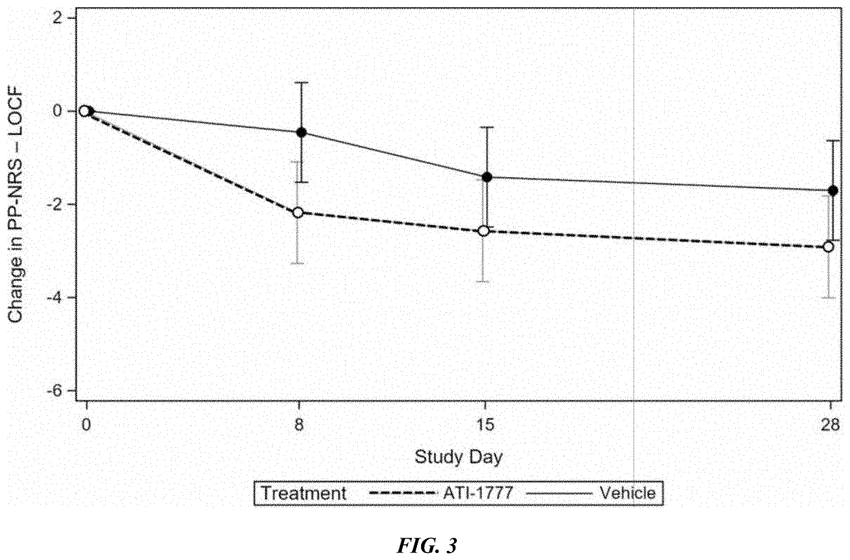

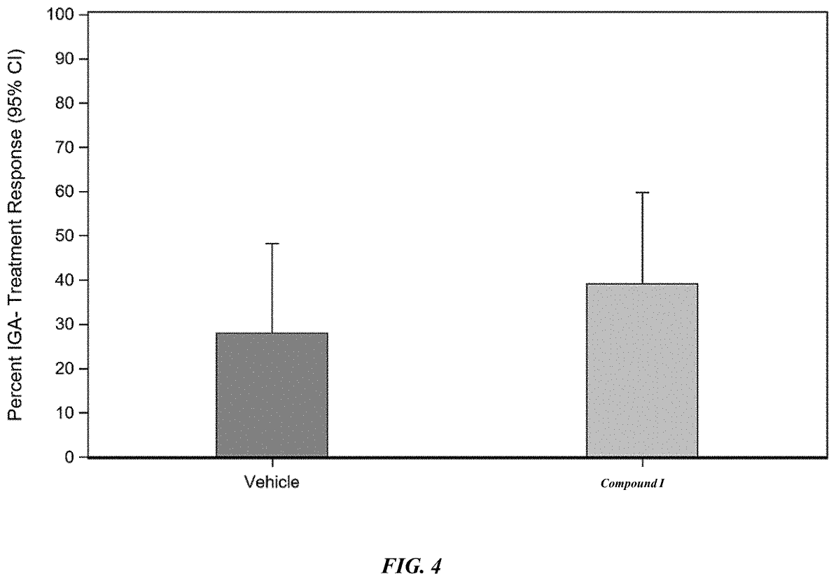

FIGS. 3A-3C illustrate an embodiment of an encapsulation structure including an inner encapsulation pouch 160 insertable into inner chambers 104A, 104C, 104E of encapsulation structures 102A, 102C, 102E. As shown in FIGS. 3B-3C, the encapsulation pouch 160 is formed of a polymer bladder filled with PCM 106. In an illustrative embodiment the bladder or pouch 160 is formed of multiple heat sealable layers 162, 164 connected along perimeter seams 165 to form an inner pouch chamber 166 as shown in FIG. 3B. The inner pouch chamber 166 is filled with the PCM material 106 and the filled pouch 160 is inserted into the inner chamber 104A, 104C or 104E formed between upper and lower layers 108, 110 of the encapsulation structures 102A, 102C, 102E to provide multiple encapsulation layers enclosing the PCM material 106 as shown in FIG. 3C.

FIG. 3D illustrates process steps for fabricating the inner pouch 160 shown in FIGS. 3A-3C. As shown, layers 162, 164 are connected to form perimeter seams 165a-165c and fill opening 168 as shown in step 170. In step 172, PCM material is injected into pouch 160 through fill opening 168 and in step 174 the fill opening 168 is sealed to form seam 165d enclosing the inner pouch chamber 166. It should be understood that while a particular embodiment is shown, application is not limited to a pouch with four seams and a folded layer can be sealed along three sides to form the pouch 160.

FIG. 3E progressively illustrates fabrication of a panel 100 including multiple encapsulation structures 102A-102E, where structures 102A, 102C, 102E include the inner pouch 160. As shown in step 180, the upper and lower layers 108, 110 are sealed to form encapsulation seams 112a-112h, fill openings 122 and baffle features 115. In step 182, the inner chambers 104B, 104D of the quilted encapsulation structures are filled with PCM material through fill openings 122 and in step 184 the fill openings 122 are sealed for encapsulate structures 102B, 102D. As progressively shown in steps 186, 188 inner pouches 160 filled with PCM are inserted into the inner chambers 104A, 104C, 104E of encapsulation structures 102A, 102C, 102E through fill openings 122 and the fill openings 122 are sealed in step 190 to complete seam 112d for encapsulation structure 102A, 102C, 102E as illustrated in FIG. 3E.

The panels of the present application can be combined to form an assembly or horse blanket 200 for cooling a horse. FIGS. 4A-4B illustrate an embodiment of a plurality of cooling panels 100_1, 100_2, 100_3 cooperatively forming the horse blanket 200. In the embodiment shown, the blanket 200 includes front panel 100_1, center panel 100_2 and a hind panel 100_3. The center and hind panels 100_2, 100_3 are generally rectangular shaped and the front panel 100_1 has contoured forward edge shaped to accommodate the neck and head of the horse. The elongate length of each of the panels includes a mid-section 202 for placement on a back of a horse as shown and extended sides sections that hang down the sides of the horse. The mid-section 202 includes encapsulation structure 102A_1, 102A_2, 102F_1, 102F_2 and the side sections include encapsulation structures 102B_1-102E_1 and 102B_2-102E_2 to form the panels 100_1-100_3 similar to the embodiment previously shown in FIGS. 2A-2B. The encapsulation structures 102A_1, 102A_2, 102F_1, 102F_2 of the mid-section 202 are weighted and shaped to support the panels and blanket 200 on the horse.

The panels have an upper side 210 shown in FIG. 4A formed via the upper layer(s) 108 and an underside 212 formed via the lower layer(s) 110 as shown in FIG. 4B. As shown in FIG. 4A, the upper side 210 of each of the panels includes a handle 214 in the mid-section 202 for movement and transport of the panels 102_1 through 102_3. The underside 212 of the panels 102_1-102_3 include ties 216 connected to the lower layer(s) 110 to tie and secure the panels in a rolled position shown in FIG. 4A. Thus, following use, the panels 102_1-102_3 can be rolled and tied for transport and cooling as shown in FIG. 4A. For cooling the rolled panels 102_1-102_3 are placed in a refrigerator or in a cooler filled with ice and/or ice or cold water.

Panels 102_1-102_3 include an edge portion or flaps 217 to overlap the underside 212 of an adjacent panel to assure that the blanket 200 covers the horse without gaps or separation. As shown in detail in FIGS. 4C-4D, panels 102_1-102_3 are connected to form the blanket 200 through a plurality of fastener tabs 118 including a first fastener element which connects to a second fastener element on an adjacent panel In the embodiment shown in FIGS. 4D-4E, the first fastener element includes a first magnet 220 supported within a pocket 222 of the fastener tab 218 which interfaces with a second magnet 224 forming the second fastener element along a back end of the adjacent panel. The magnets 220, 224 are designed to provide sufficient holding force to retain the panels 101_1, 100_2, 102_3 in place for use. As shown in detail in FIG. 4E, the pocket 222 of the fastener tab 210 is formed between upper and lower layers 108, 110 of panels 100_1-100_2 to contain the first magnet 220.

FIG. 4F progressively illustrates process steps for fabricating the fastener tab 218 for the first magnet 220. As shown in step 230, seams 112 and baffle features 115 are formed connecting the upper and lower layers 108, 110. In step 232, magnet 220 is inserted between the upper and lower layers of the fastener tabs 218 and layers 108, 110 are connected along seam 112i-112j to retain the magnet 220 in pocket 222 of tab 218 as shown in steps 234, 236.

In illustrative embodiments, the second magnet 224 is contained in a pocket 240 of inner pouch 160 as shown in FIG. 4G to support the second magnet 224 at a back end of the encapsulation structures 102A_1, 102A_2, 102C_1, 102C_2, 102E_1, 102E-2 to interface with the first magnet 220 on the fastener tabs 218. As shown in FIG. 4H, upper and lower pouch layers 162, 164 are connected along seams 165a-165c to form the pouch chamber 166 having an elongate length as shown in step 242. As shown in step 244 pouch is filled with PCM and chamber 166 is sealed along seam 165d in step 246. The second magnet 224 is placed between the upper and lower layers 162, 164 of an extended length portion and in step 250, the layers are sealed to form the magnet pocket 240 for the second magnet 224. Prior to insertion in chambers 104A, 104C, 104E, the pocket 240 is folded over in step 252 as shown in FIG. 4H so that magnet 224 interfaces with the first magnet 220 to connect adjacent panels.

In other embodiments as shown in FIG. 4I, the blanket includes panels 100_1, 100_2 connected through hook and loop fastener elements 255 to removably connect the panels 100_1, 100_2 for use. Fastener elements used in various embodiments may alternatively include zippers, ties, snaps or other releasable types of attachments.

The panels used in the horse blanket, such as panels 100_1, 1002, and 100_3 and panels 102_1, 102_2, and 102_3 may be sized to extend across a horse's back and against it's sides. In some embodiments, the panels may be approximately 40 to approximately 60 inches long or approximately 45 to approximately 55 inches long, and approximately 20 to approximately 30 inches wide, such as approximately 48 inches long and 25 inches wide, though other dimensions are possible.

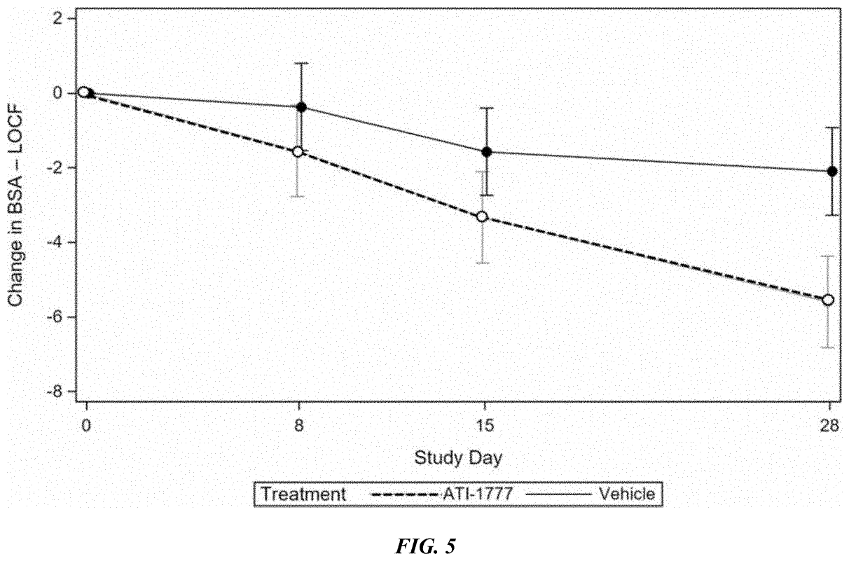

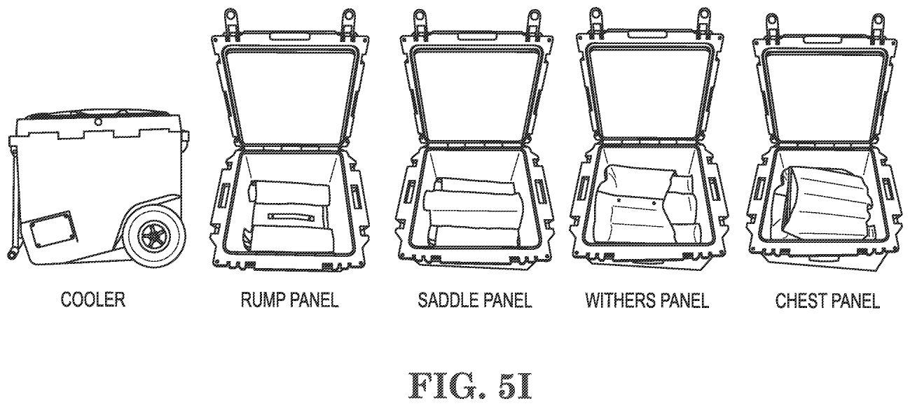

FIG. 5A illustrates an embodiment of a cooling collar or chest panel 260 for a front of the horse. In the embodiment shown, the collar 260 is formed of a generally semi-circular shaped panel to fit around a neck of the horse. In the embodiment shown, the collar 260 includes a plurality of encapsulation structures 102A-102H. The encapsulation structures 102A and 102H include baffle features 115 and encapsulation structures 102B-102G are formed of irregular shaped encapsulation structures. Each of the encapsulation structures 102A-102H is formed of upper and lower layers as previously described. The panel includes handles 262 on the upper side 21—of the panel on opposed ends of the panel for placement of the cooling collar 260 on a horse. An underside 212 of the opposed ends of the panel include a hook and loop fastener element 264 as shown in FIG. 5B to attach the cooling collar for use. In an illustrative embodiment, ends of the panel or cooling collar 260 include a rigid plate or body between upper and lower layers. Handles 262 are connected to the rigid plates or body through screws or other fasteners as shown.

FIG. 5C is a detailed view of the cooling collar 260 and encapsulation structures 102A-102H. In an alternate embodiment shown in FIG. 5D, the collar 260 includes encapsulation structure 102A-102J, which do not include baffle features 115. The collar 260 shown in FIG. 5D would also include a rigid plate or body with handles 262 and hook and loop fastener element 264 as previously described for the embodiment shown in FIGS. 5A-5C and as shown in FIG. 5F.

In an illustrated embodiment the cooling collar 260 is supported via a collar support 270 as shown in FIGS. 5E-5F. The collar support 270 has support pad 272 for the placement on the back of the horse and elongate tails 274 extending from the support pad 272. The elongate tails 274 are formed of a flexible elastic banded material having interwoven elastic bands including hook and loop fastener features 275 that interface with the hook and look fasteners 264 on the underside 212 of the collar panel 260 to connect the collar panel 260 to the collar support 270 around the neck of the horse. As shown, ends 276 of tails 274 include fastener elements to connect the ends 276 of tails 274 together. Although a particular collar and support design are shown, application is not limited to the particular design or embodiments shown.

As previously described with respect to FIG. 4A, the panels 100_1, 1002, 100_3 are rolled and tied to fit the panels 100_1, 100_2, 100_3 in a portable cooler for charging as shown in FIGS. 5G-5I. In an illustrative embodiment, panels 100_1, 100_2, 100_3 and collar 260 (or chest panel) shown in FIG. 5A fit in the cooler as progressively illustrated in FIG. 51. The panels 100_1, 1002, 100_3 and collar 260 can be charged in one hour by rolling up the panels (and collar or chest panel) one at a time and placing them in a cooler filled with ice and cold water. The cover of the cooler is closed and the panels will be ready in about an hour. Alternatively, the panels and collar can be charged in a refrigerator or powered refrigeration unit and ready for use in as little as four hours. To charge the panels in a refrigerator or powered refrigeration unit, roll the panels and place them in the refrigerator. The panels will hold their charge or stay cool for up to 8 hours.

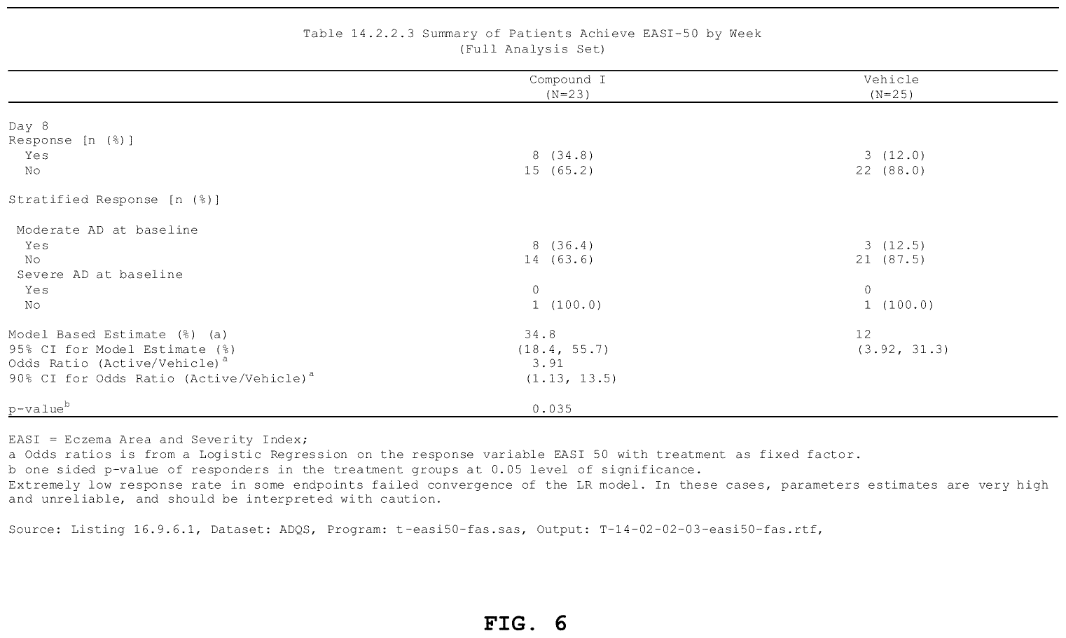

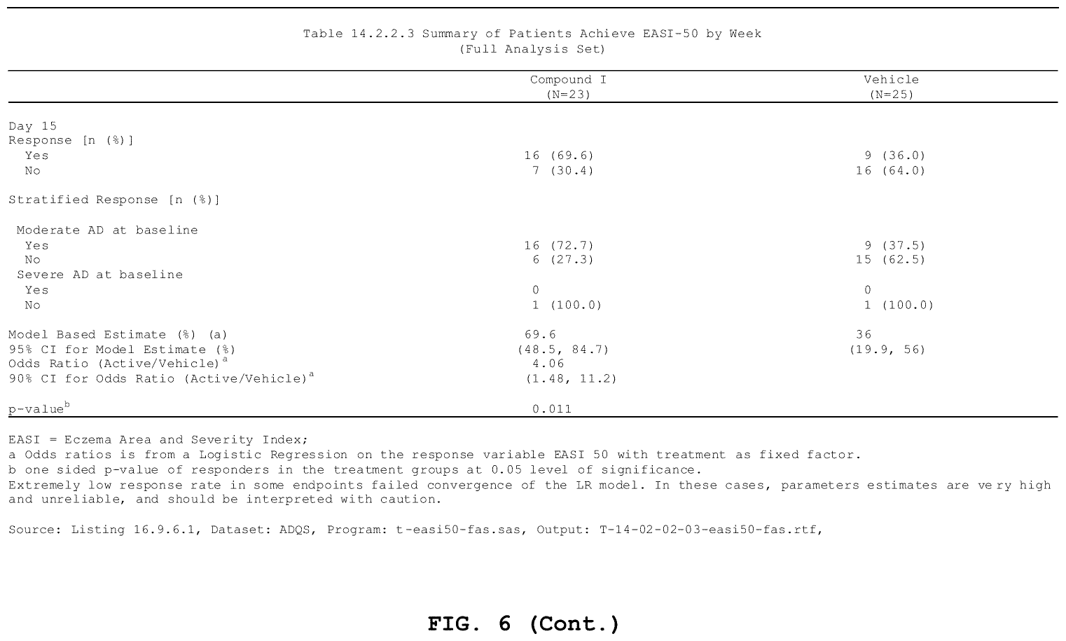

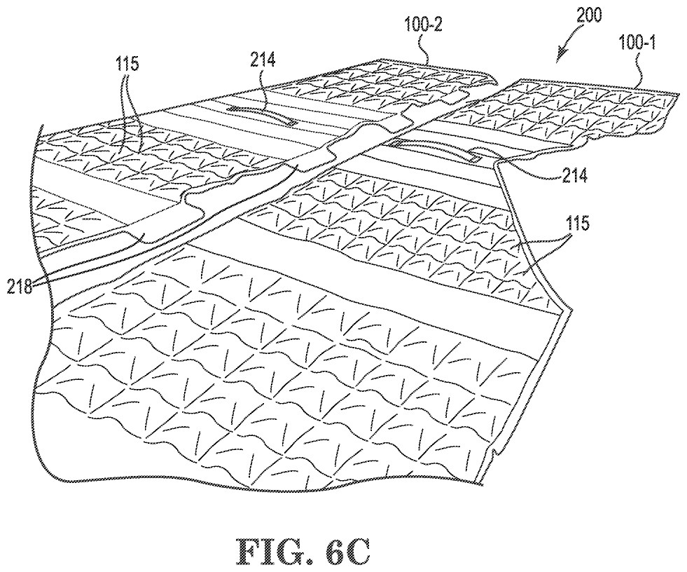

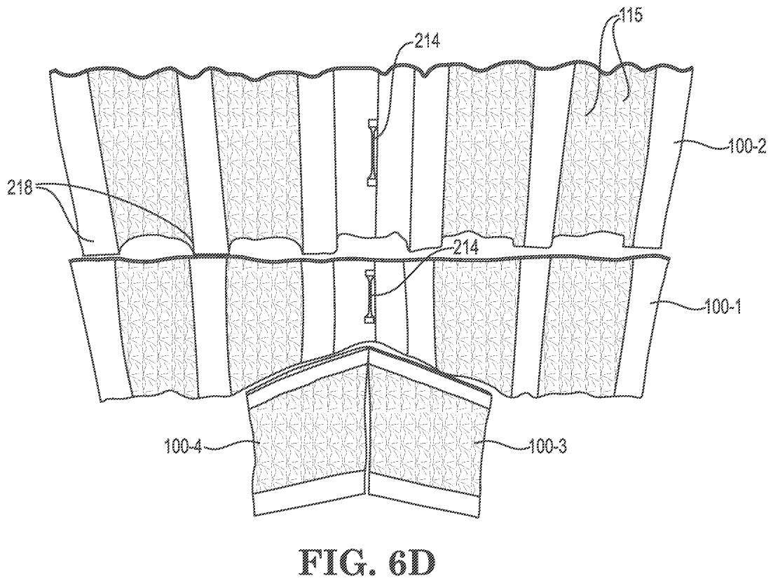

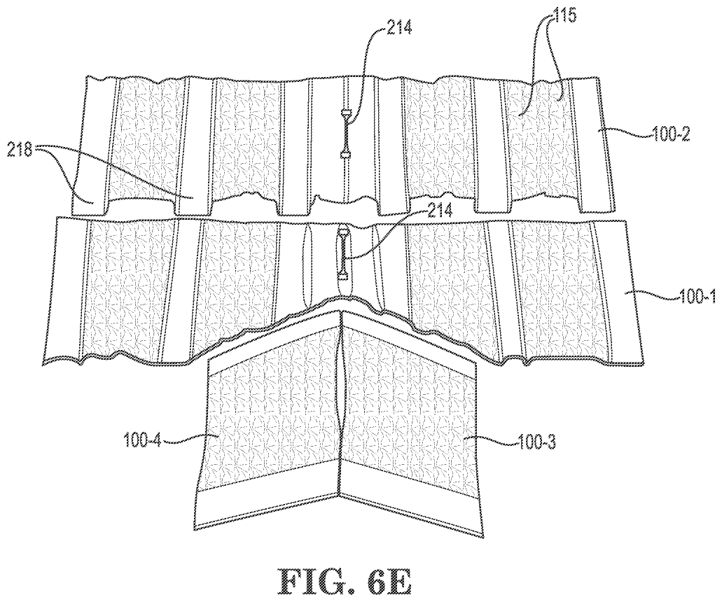

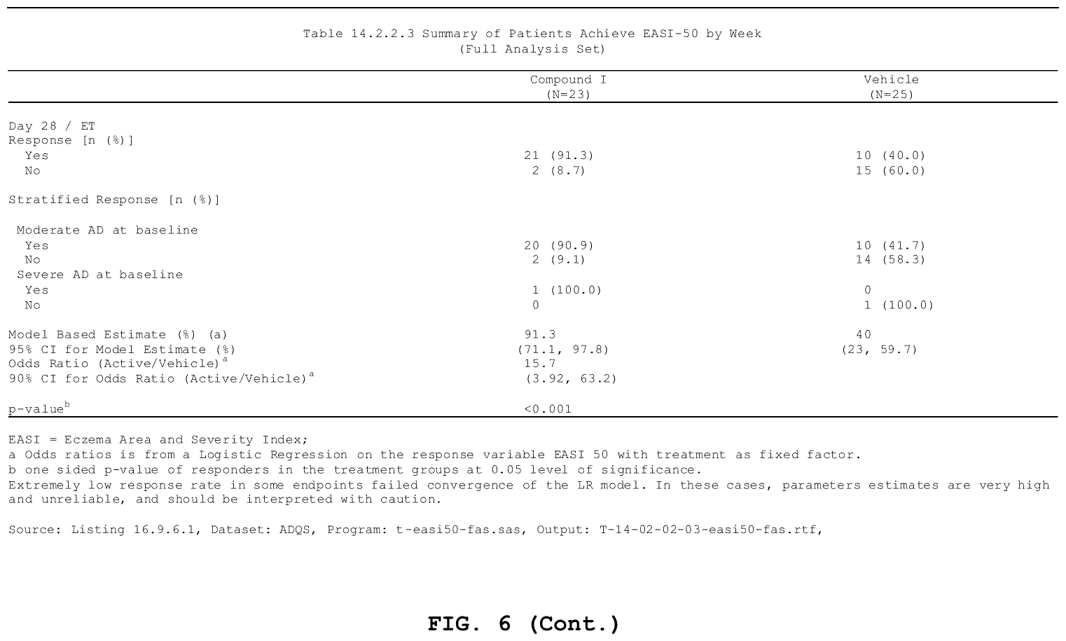

FIGS. 6A-6E illustrate alternate embodiments for horse blankets 200 of the present application where like numbers are used to identify like parts. In the embodiment shown in FIG. 6A, the blanket includes panels 102_1, 102_2 including encapsulation structures 102A, 102B having baffle features 115 and collar panels 102_3, 102_4 including encapsulation structures 102C with baffle features. FIG. 6B is similar to FIG. 4A and includes collar panels 100_4, 100_5 with baffle features 115. FIGS. 6C-6E illustrate additional embodiments for a horse blanket 200 similar to FIG. 4A including panels 100_1, 100_2 and collar panels 100_3, 100_4 as shown in FIGS. 6D-6E.

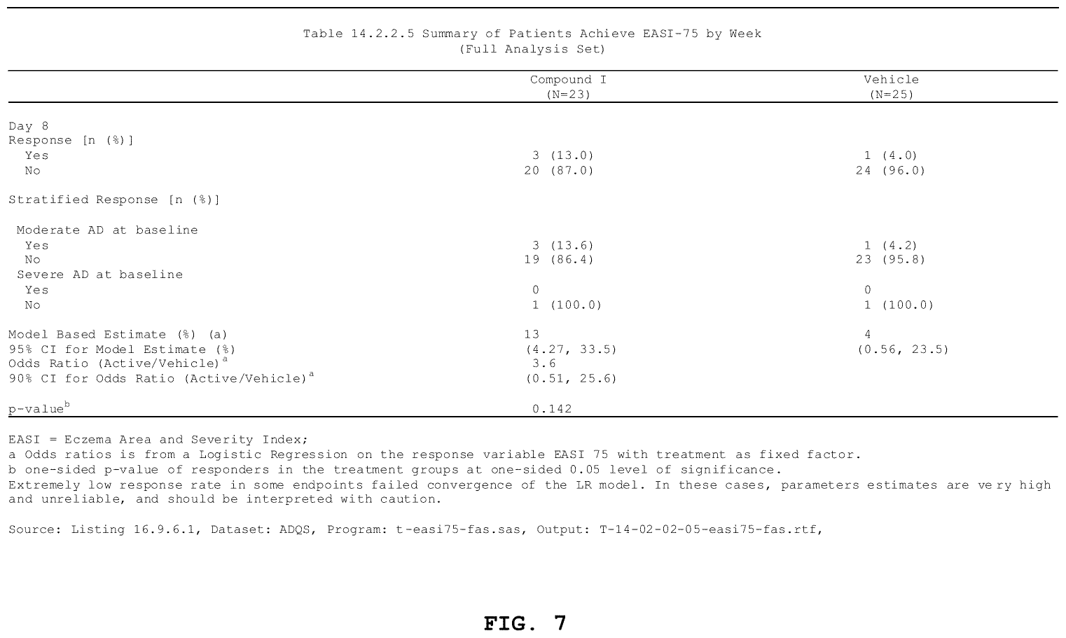

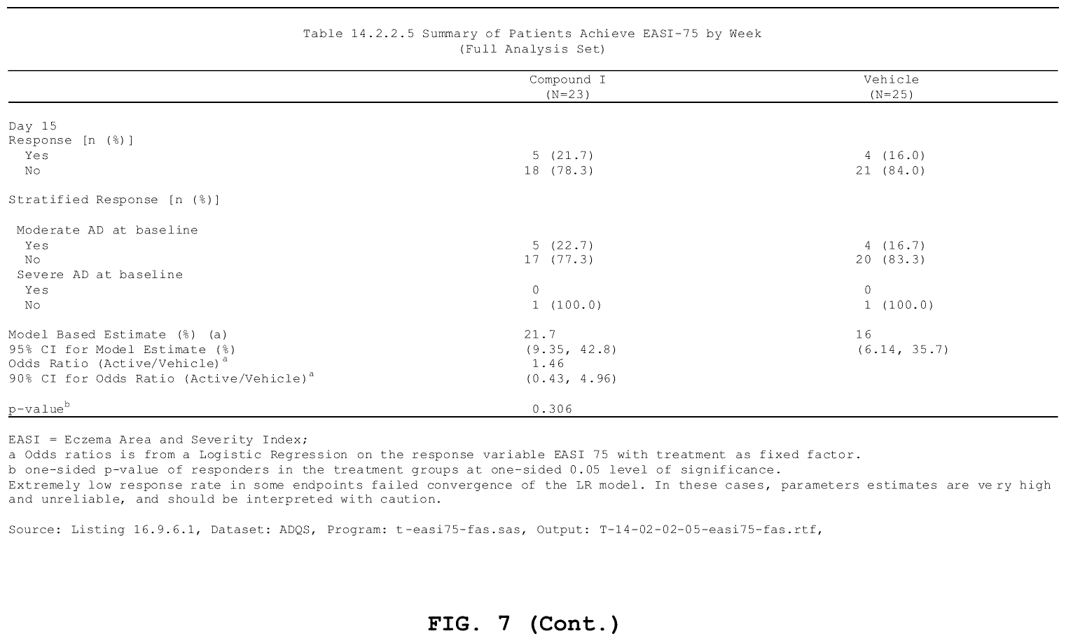

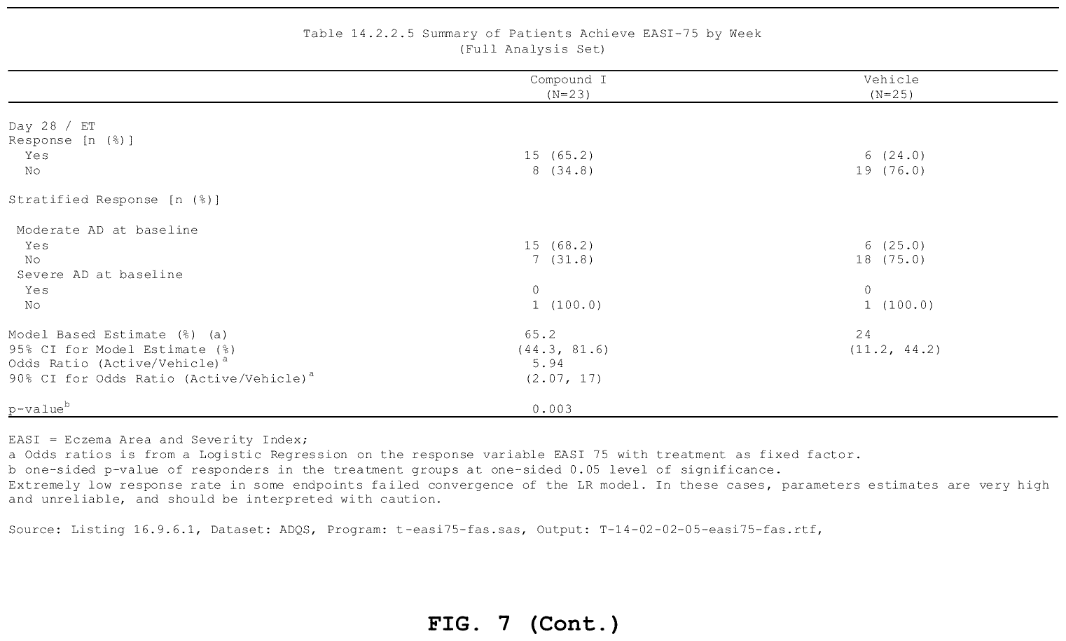

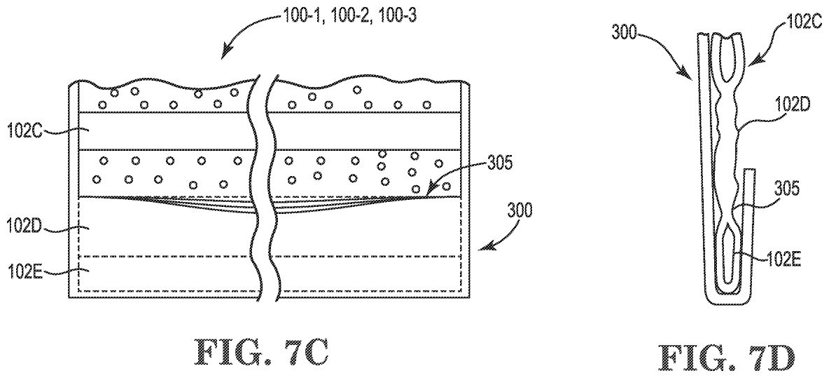

FIGS. 7A-7B illustrate a fly sheet 300 sized to fit over the cooling blanket 200 and panels and hold the cooling panels 100_1-100_3 in place on the horse. The fly sheet 300 is sized to fit over the back of the horse and includes a back portion, a front portion and opposed side portions. The front portion as shown includes a collar opening 302 for the horse's head. The fly sheet 300 is secured to the horse through an attachment strap 304 as shown in FIG. 7B. The attachment strap or band 304 is connected to one side of the fly sheet and wraps under the belly of the horse to attach to the opposite side portion through a fastener such as a hook and loop fastener. As shown in FIGS. 7C-7D, a bottom edge of the fly sheet 300 includes a panel pocket 305 sized to support the bottom edges of the panels 102_1, 102_2, 102_3 to retain the panels in place. In illustrative embodiments, the fly sheet 300 is formed of lyra® material available from Lyra Company LLC of Delaware or similar material. While illustrative embodiments have been described, application is not limited to the illustrated embodiments and changes and modifications can be made as will be appreciated by those skilled in the art.

To assemble embodiments of the horse blanket 200, place the collar support or neck band 270 as shown in FIGS. 5E-5F on the horse and secure the collar or chest panel 260 to the collar support or neck band as shown in FIG. 5F. Place the first panel on the horse's back allowing the panel to fall down both sides of the horse. Place the second panel on the horse's back and align the first and second panels so that the magnets on tabs lock into place. Similarly, place the third panel on the horse and align the magnets to connect the third panel in place as shown in FIG. 7E. Place the fly sheet over the horse and panels and tuck the collar and panels into the panel pockets 305 on each side of the horse. Connect the belly band 304 under the horse to secure the panels for use. Illustrated embodiments of the cooling panels and collar will absorb heat while maintaining a constant temperature of 64 degrees F. for 2 hours or more of weighted cooling comfort.

For storage and cleaning, after use hang the cooling panels on a rack to dry. Once the panels are dry, store the panels in a refrigerator or hang them on a rack. If the panels are soiled, the panels may be cleaned with a mild detergent and water using a soft brush. Rinse off any soapy residue with water using a hose and hang the panels on a rack to dry.

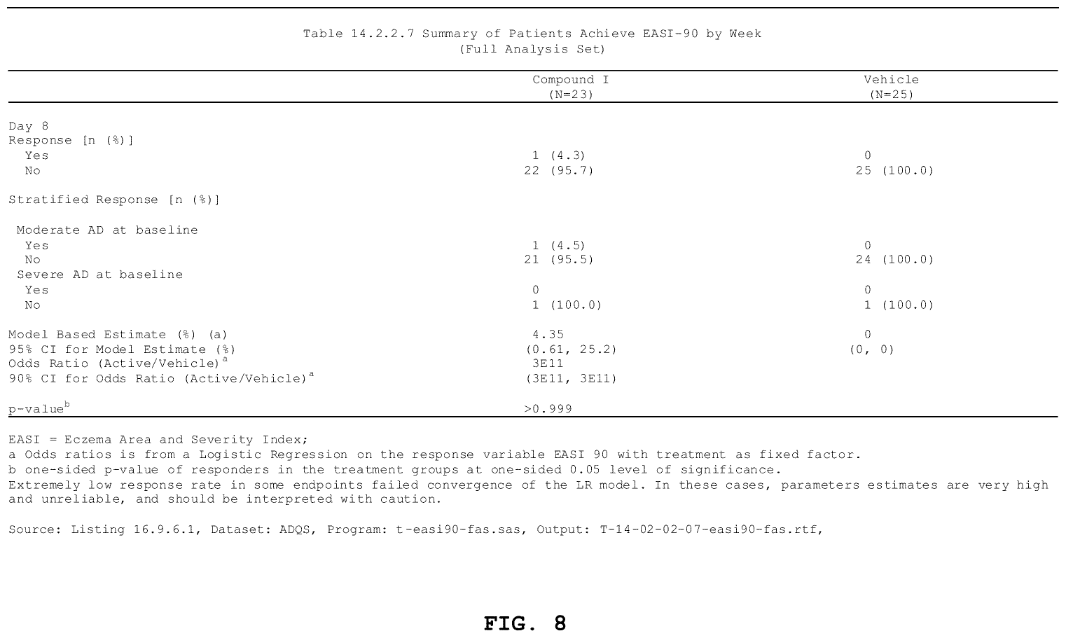

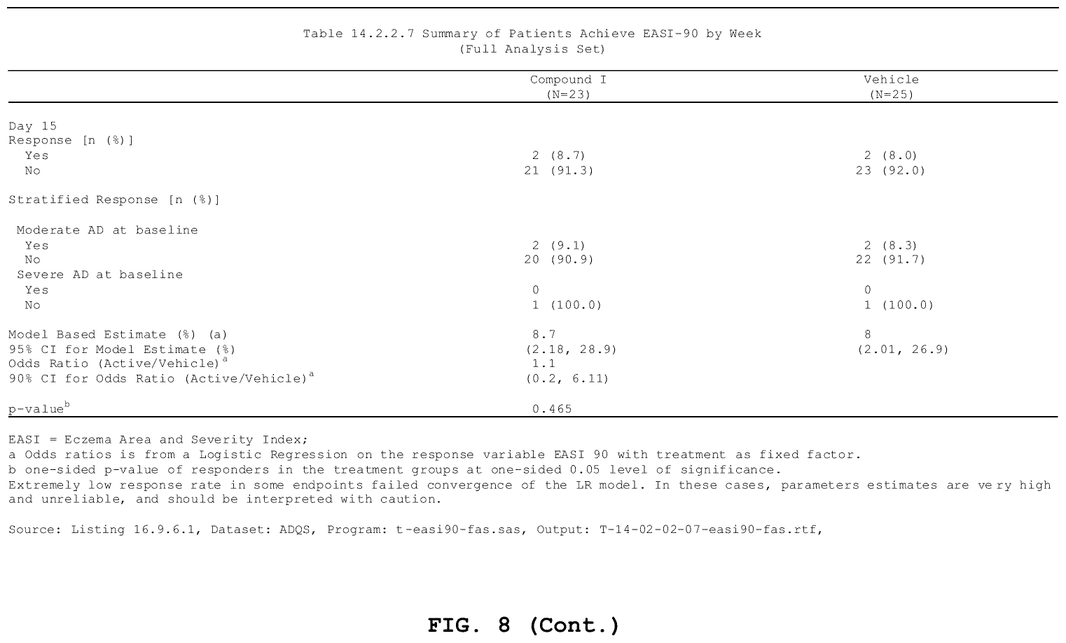

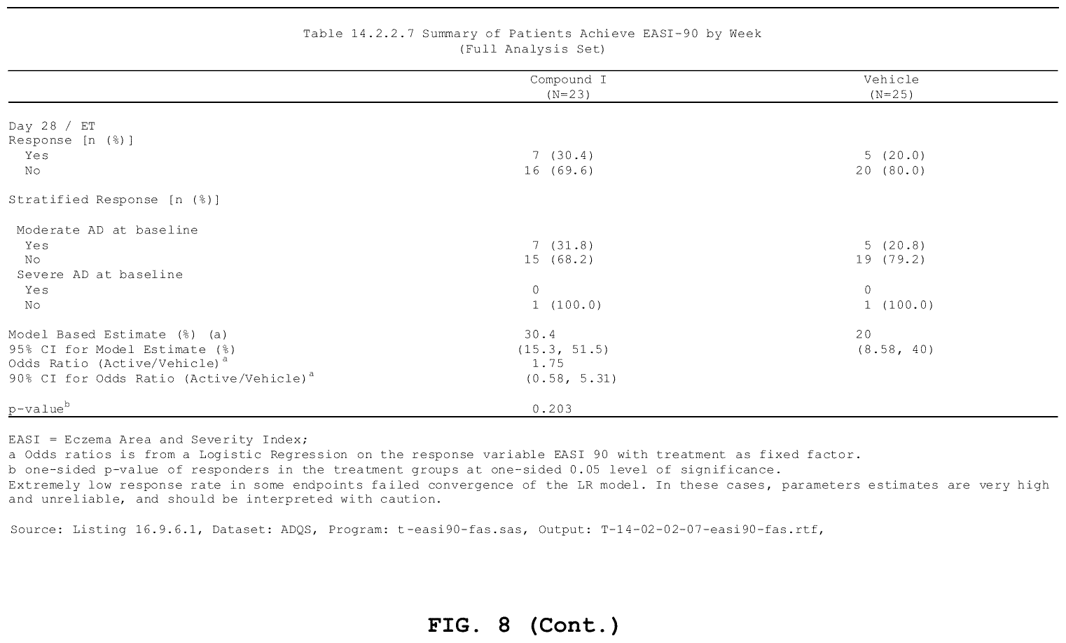

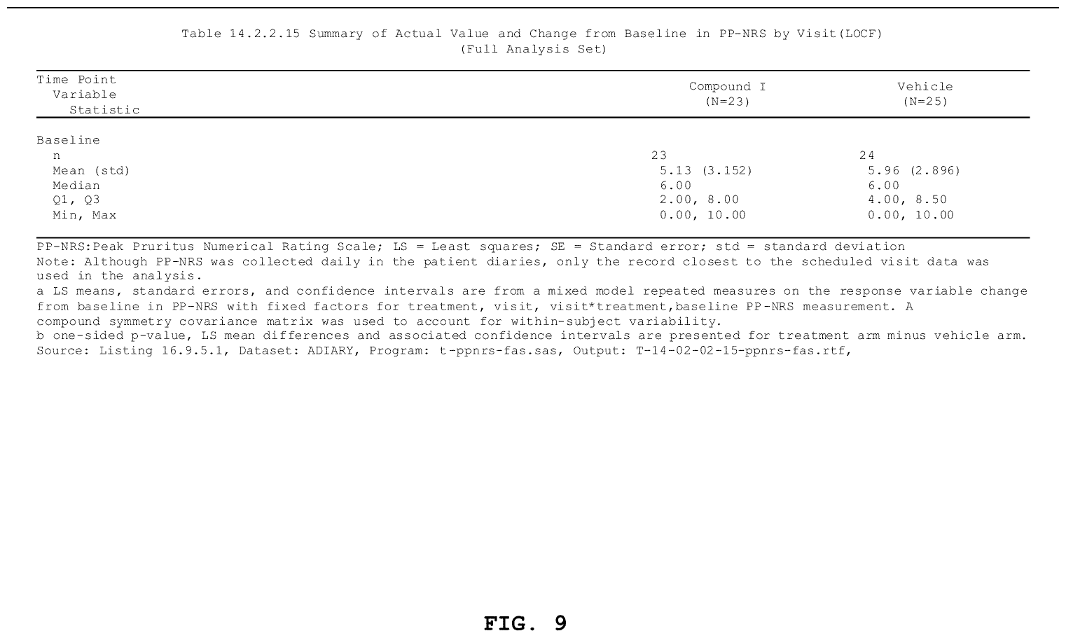

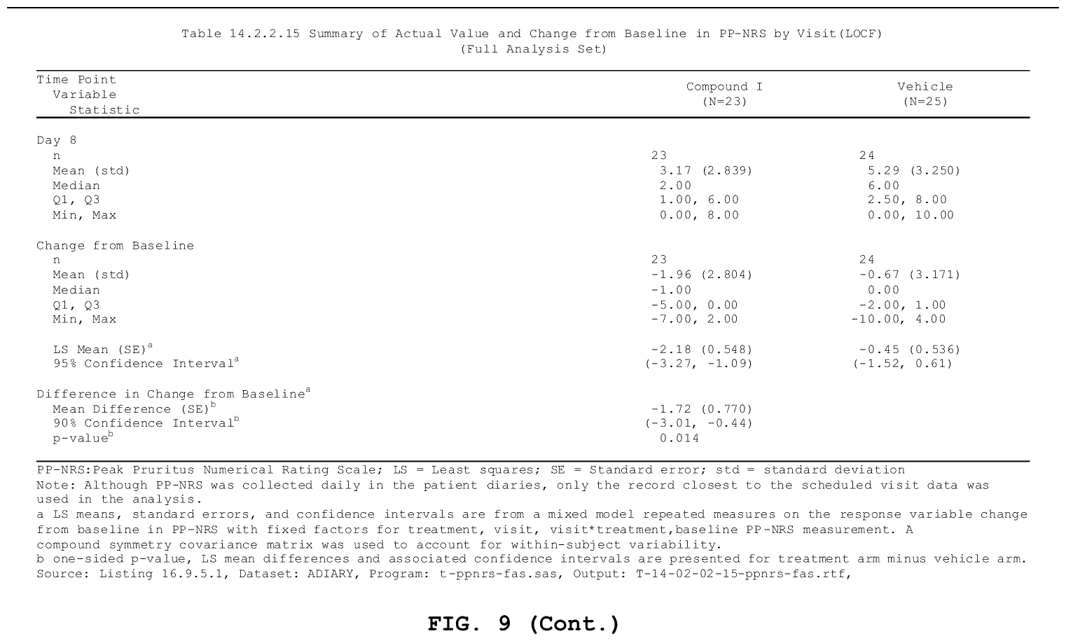

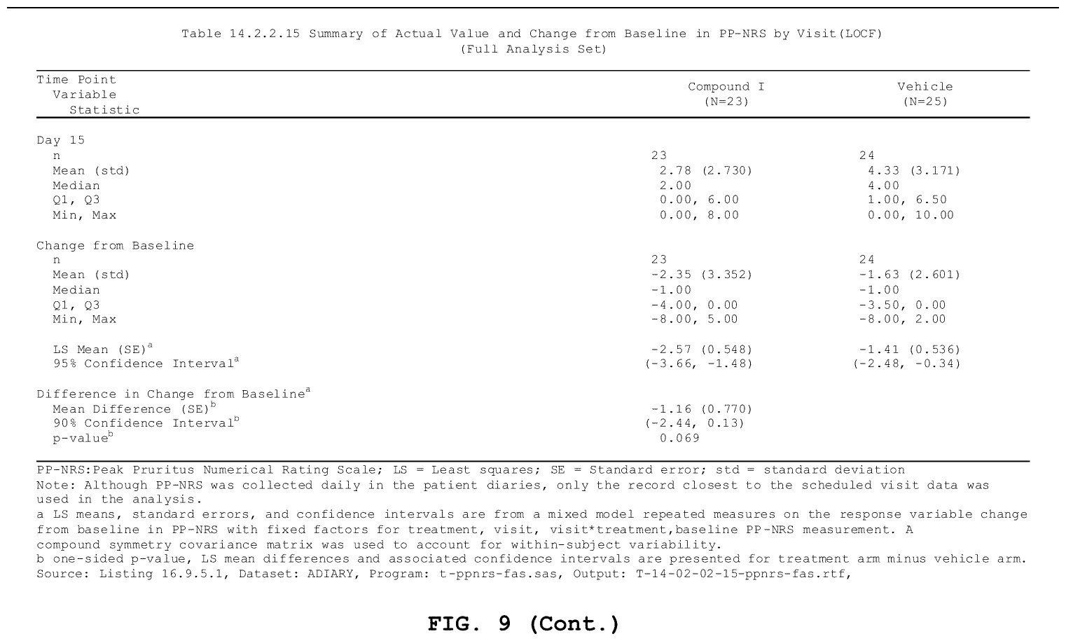

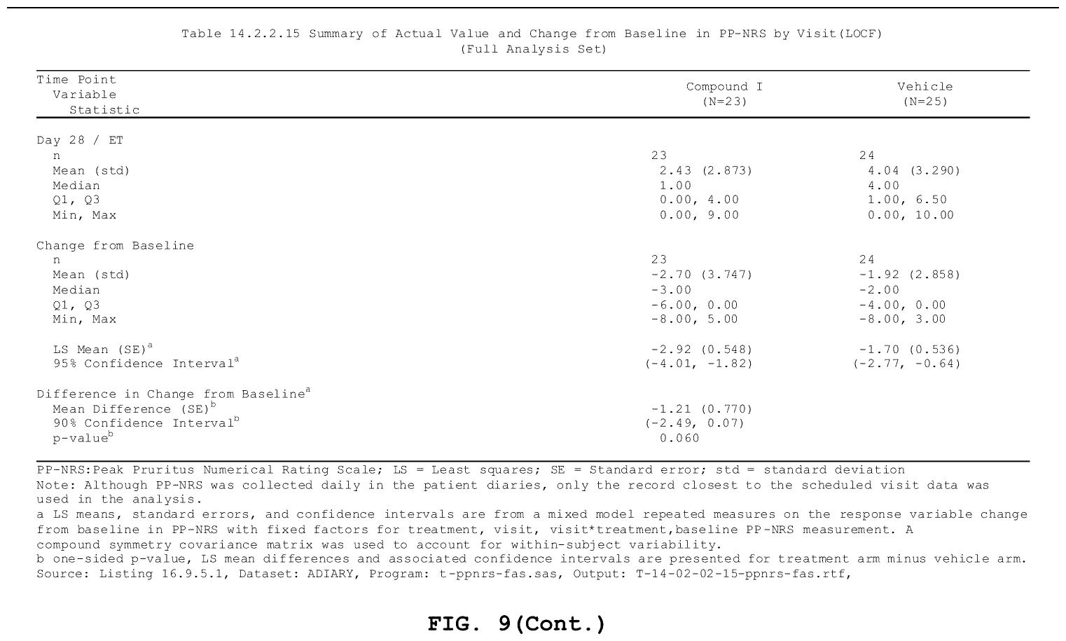

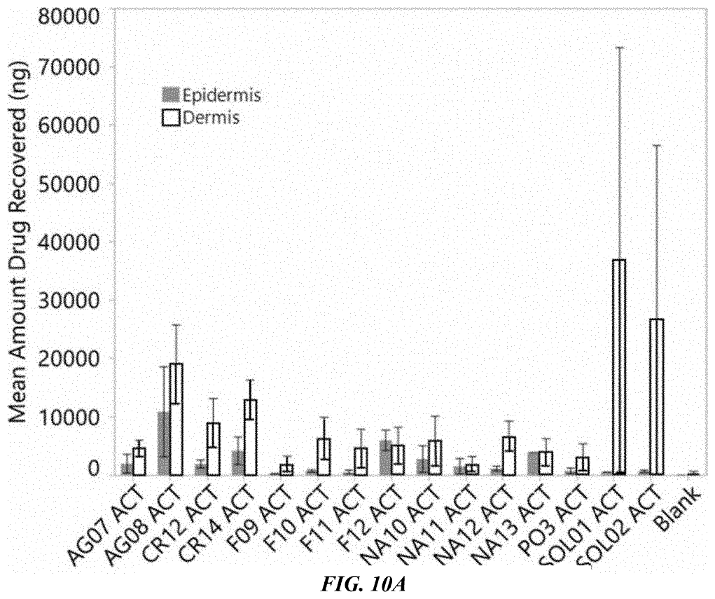

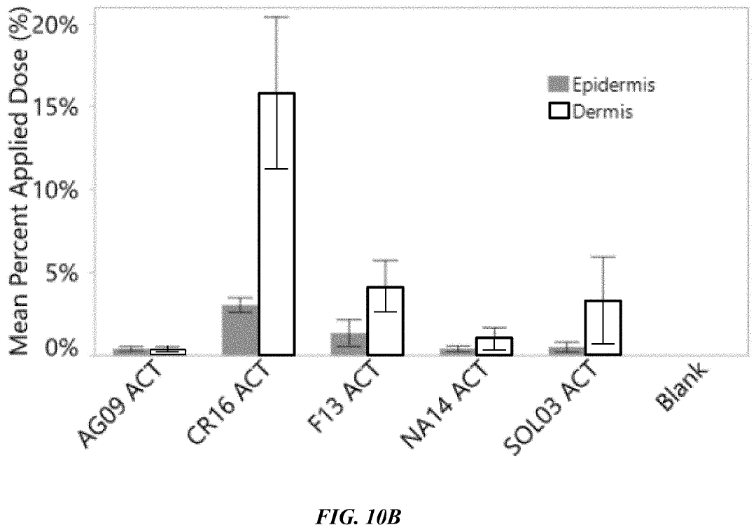

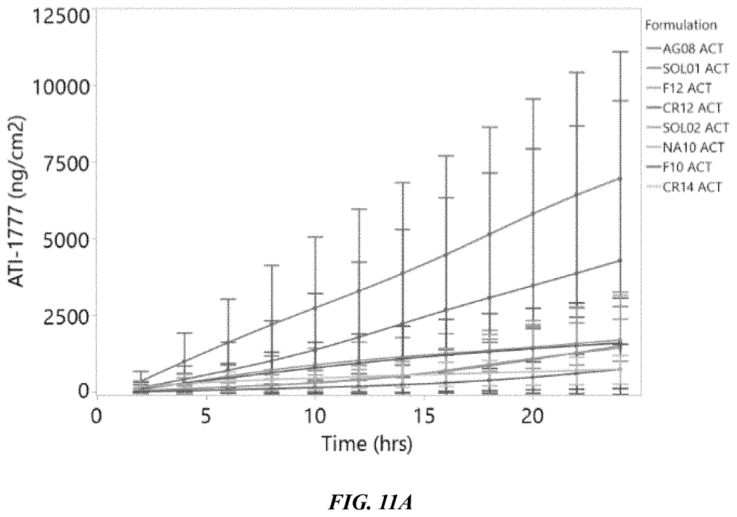

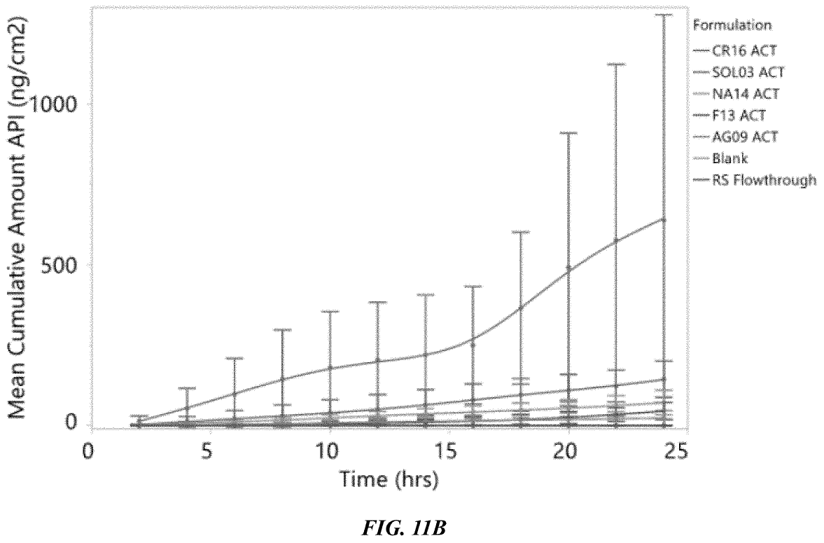

FIGS. 8A-8C illustrate alternate shaped panels and encapsulation structures forming different products including a vest 400 illustrated in FIGS. 8A-8B and leg wrap 402 as shown in FIG. 8C. As shown, the encapsulation structure of the vest 400 includes a plurality of baffle features 115 to provide a flexible and wearable garment that provides cooling. Similarly, the leg wrap in FIG. 8C includes an encapsulation structure having baffle features 115 and fastener elements 404 to wrap around and connect to the leg of an animal or horse for use.

Embodiments of panels 100 and blanket 200 described include baffle features 115 to provide a light weight and bendable/flexible cooling structure. The panels as described also include ribs between baffle structures to provide weight and rigidity to the panel and blanket 200. In illustrated embodiments, the weight of the panels ranges between 15-20 lbs which comforts and calms the horse for transport. While the present application describes illustrative embodiments, application is not limited to the illustrated embodiments described, and changes and modifications can be made as will be appreciated by those skilled in the art. In particular, while particular shapes are disclosed for the panel or encapsulation structures, application is not limited to the particular shapes shown. Furthermore, while a particular, feature design or shape is shown, application is not limited to the particular baffle feature or design shown.

What is claimed is:

1. A cooling blanket for cooling a body of a human or animal comprising:
a first panel having a generally rectangular shape with first and second opposing edges and with third and fourth opposing edges, the first panel comprising:
an upper layer of weldable material;
a lower layer of weldable material adjoined to the upper layer of weldable material along the first, second, third and fourth opposing edges;
a plurality of linear welds connecting the upper layer to the lower layer, the plurality of linear welds extending across the panel from the first to the second edges;
a plurality of chambers extending across the panel from the first to the second edges and containing phase change material; and
a fastener element located at the second edge; and
a second panel having a generally rectangular shape with first and second opposing edges and with third and fourth opposing edges, the second panel comprising:
an upper layer of weldable material;
a lower layer of weldable material adjoined to the upper layer of weldable material along the first, third and fourth, second opposing edges;
a plurality of linear welds connecting the upper layer to the lower layer, the plurality of linear welds extending across the panel from the first to the second edges;
a plurality of chambers extending across the panel from the first to the second edges and containing phase change material; and
a fastener element located at the first edge, wherein the fastener element of the first panel is configured to releasably connect to the fastener element of the second panel to form the cooling blanket.

2. The cooling blanket of claim 1 wherein the phase change material comprises pellets of a phase change material suspended in an aqueous gel.

3. The cooling blanket of claim 1 wherein the fastener elements of the first and second panel comprise magnets.

4. The cooling blanket of claim 1 wherein the first and second panels both further comprising a handle.

5. The cooling blanket of claim 4 wherein the handles are located midway between the third and fourth edges of the first and second panels.

6. The cooling blanket of claim 1 wherein the second panel further comprises a flap located at the first edge and extending from the third to the fourth edges, wherein the fastener element of the second panel is located in the flap.

7. The cooling blanket of claim 6 wherein, when the first and second panels are connected by the fastener elements, the flap of the second panel overlaps the second edge of the first panel.

8. The cooling blanket of claim 1 further comprising a plurality of elongated encapsulation pouches insertable into, and removable from, the plurality of chambers, wherein the encapsulation pouches contain phase change material.

9. The cooling blanket of claim 1 wherein the first edge extends inward, toward a center of the first panel, at a center of the first edge to form a notched portion.

10. The cooling blanket of claim 8 wherein the notched portion is sized to fit around a base of a neck of a horse.

11. A cooling blanket for horse comprising:
a first panel configured to lie across a back of a horse, the first panel having a generally rectangular shape with first and second opposing edges and with third and fourth opposing edges, the first panel comprising:
an upper layer of weldable material;
a lower layer of weldable material adjoined to the upper layer of weldable material along the first, second, third and fourth opposing edges;
a plurality of linear welds connecting the upper layer to the lower layer, the plurality of linear welds extending across the panel from the first to the second edges;
a plurality of chambers extending across the panel from the first to the second edges and containing phase change material; and
a fastener element located at the second edge; and
a second panel configured to lie across a back of a horse behind the first panel, the second panel having a generally rectangular shape with first and second opposing edges and with third and fourth opposing edges, the second panel comprising:
an upper layer of weldable material;
a lower layer of weldable material adjoined to the upper layer of weldable material along the first, second, third and fourth opposing edges;
a plurality of linear welds connecting the upper layer to the lower layer, the plurality of linear welds extending across the panel from the first to the second edges;
a plurality of chambers extending across the panel from the first to the second edges and containing phase change material; and
a fastener element located at the first edge, wherein the fastener element of the first panel is configured to releasably connect to the fastener element of the second panel; and
a third panel configured to encircle a neck of a horse on its chest, the third panel being generally C-shaped and having a first and second curved opposing edges and with first and second outer ends; the third panel comprising:
an upper layer of weldable material;
a lower layer of weldable material adjoined to the upper layer of weldable material along the first and second curved opposing edges;
a plurality of linear welds connecting the upper layer to the lower layer, the plurality of linear welds extending across the panel from the first to the second curved edges;
a plurality of chambers extending across the panel from the first to the second curved edges and containing phase change material; and
a pair of fastener elements located at the first and second outer ends and configured to releasably connect to each other.

12. The cooling blanket of claim 10 wherein the third panel further comprises a pair of handles located in proximity to the first and second outer ends.

13. The cooling blanket of claim 10 the phase change material comprises pellets of a phase change material suspended in an aqueous gel.

14. The cooling blanket of claim 10 wherein the fastener elements of the first and second panel comprise magnets or hook and loop fasteners.

15. The cooling blanket of claim 10 wherein the first and second panels both further comprising a handle located midway between the third and fourth edges of the first and second panels.

16. The cooling blanket of claim 14 wherein the second panel further comprises a flap located at the first edge and extending from the third to the fourth edges, wherein the fastener element of the second panel is located in the flap and wherein, when the first and second panels are connected by the fastener elements, the flap of the second panel overlaps the second edge of the first panel.

17. The cooling blanket of claim 1 further comprising a plurality of elongated encapsulation pouches insertable into, and removable from, the plurality of chambers, wherein the encapsulation pouches contain phase change material.

18. The cooling blanket of claim 10 wherein the first edge extends inward, toward a center of the first panel, at a center of the first edge to form a notched portion sized to fit around a base of a back of the neck of a horse.

19. The cooling blanket of claim 17 wherein the second edge of the second panel flares outward at a center of the second edge to extend across a rear portion of the horse.

20. The cooling blanket of claim 10 wherein some of the chambers of the first and second panels include spot welds connecting the upper layer to the lower layer.
